(19) United States
(12) Patent Application Publication
(10) Pub. No.: US 2025/0012477 A1
(43) Pub. Date: Jan. 9, 2025

(54) AIR CONDITIONING UNIT AND PACKAGING UNIT

(71) Applicant: DAIKIN INDUSTRIES, LTD., Osaka (JP)

(72) Inventors: Kengo UCHIDA, Osaka (JP); Eiji KUMAKURA, Osaka (JP)

(73) Assignee: DAIKIN INDUSTRIES, LTD., Osaka (JP)

(21) Appl. No.: 18/889,544

(22) Filed: Sep. 19, 2024

Related U.S. Application Data
(63) Continuation of application No. PCT/JP2023/009180, filed on Mar. 9, 2023.

(30) Foreign Application Priority Data
Mar. 30, 2022 (JP) 2022-056624

(51) Int. Cl. F24F 11/89; A62C 99/00

(52) U.S. Cl. CPC F24F 11/89; A62C 99/0018

(57) ABSTRACT

To provide an air conditioning unit and a packaging unit that can be safely stored while suppressing mixing of unnecessary substances. In an outdoor unit, a refrigerant having flammability is enclosed. An enclosure amount of the refrigerant having the flammability is equal to or more than an amount of the refrigerant that becomes an atmospheric pressure at an ambient temperature of −40° C. and less than an amount of the refrigerant that becomes 0.2 MPa at an ambient temperature of 20° C.

### CROSS REFERENCE TO RELATED APPLICATIONS

This application is s a Continuation of PCT International Application No. PCT/JP2023/009180, filed on Mar. 9, 2023, which claims priority under 35 U.S.C. § 119(a) to Patent Application No. JP 2022-056624, filed in Japan on Mar. 30, 2022, all of which are hereby expressly incorporated by reference into the present application.

### TECHNICAL FIELD

The present disclosure relates to an air conditioning unit and a packaging unit.

### BACKGROUND ART

In recent years, as interest in the global environment has increased, refrigerants with low global warming potential (hereinafter referred to as GWP) values, which do not have a great influence on the destruction of the ozone layer and global warming, have been receiving attention. Some of such refrigerants have flammability, and it is required to ensure safety so that the refrigerants are not ignited.

For example, PTL 1 (Japanese Unexamined Patent Application Publication No. 2011-094871) proposes that an outdoor unit is shipped from a factory in a state in which a non-flammable refrigerant is enclosed in a refrigerant circuit constituent part of the outdoor unit, and a required amount of a flammable or slightly flammable refrigerant is additionally enclosed in the refrigerant circuit when the outdoor unit is installed at a site where the outdoor unit is used, thereby ensuring safety.

### SUMMARY

In an air conditioning unit according to a first aspect, a refrigerant having flammability is enclosed. An enclosure amount of the refrigerant having the flammability is equal to or more than an amount of the refrigerant that becomes an atmospheric pressure at an ambient temperature of −40° C. and less than an amount of the refrigerant that becomes 0.2 MPa at an ambient temperature of 20° C.

### BRIEF DESCRIPTION OF THE DRAWINGS

FIG. 1 is a general configuration diagram of an air conditioning apparatus.

FIG. 2 is a general control block configuration diagram of the air conditioning apparatus.

FIG. 3 is a general configuration diagram of a packaging unit.

### DESCRIPTION OF EMBODIMENTS

### (1) Air Conditioning Unit

An air conditioning unit may be a device in which a refrigerant having flammability is enclosed and that can perform a refrigeration cycle, or may be a partial component for performing a refrigeration cycle. For example, the air conditioning unit may be an outdoor unit that constitutes a refrigerant circuit by being connected to one indoor unit or a plurality of indoor units via a refrigerant pipe.

Examples of the refrigerant having flammability include a highly flammable refrigerant of class A3 or B3, a flammable refrigerant of class A2 or B2, and a slightly flammable refrigerant of class A2L or B2L in ASHRAE Safety Group. The refrigerant having flammability may be one type or two or more types selected from the group consisting of R290, R600, and R600a.

The refrigerant having flammability is enclosed in the air conditioning unit. An enclosure amount of the refrigerant having flammability enclosed in the air conditioning unit is equal to or more than an amount of the refrigerant that becomes an atmospheric pressure at an ambient temperature of −40° C. and less than an amount of the refrigerant that becomes 0.2 MPa at an ambient temperature of 20° C. Although the refrigerant having flammability is enclosed in the air conditioning unit, the amount of the refrigerant is less than the amount of the refrigerant that becomes 0.2 MPa at the ambient temperature of 20° C. and is suppressed to be small. Thus, even when the refrigerant leaks from the air conditioning unit, ignition is suppressed, and storage and transportation can be performed safely. In addition, in this air conditioning unit, the enclosure amount of the refrigerant having flammability is equal to or more than the amount of the refrigerant that becomes the atmospheric pressure at the ambient temperature of −40° C. Thus, even when the ambient temperature decreases during storage or transportation, the pressure of the portion in which the refrigerant having flammability is enclosed is likely to be maintained at the atmospheric pressure or higher. Thus, mixing of air from the surroundings into the air conditioning unit is suppressed. Thus, when a refrigeration cycle operation is performed after the air conditioning unit is installed, the reliability of the operation can be improved.

### (2) Packaging Unit

The air conditioning unit is preferably stored in a state of being packaged with a packaging material. Such a packaging material preferably has gas barrier properties. For example, the packaging material preferably contains one type or two or more types selected from the group consisting of vinyl chloride, polyethylene, and polypropylene. Thus, even when the refrigerant having flammability leaks from the air conditioning unit, the spread of the leakage toward the outside of the packaging material is suppressed. In addition, mixing of air or moisture outside the packaging material into the air conditioning unit is suppressed.

The internal space of the packaging material is preferably in a low oxygen state. As the low oxygen state, for example, the oxygen concentration may be 10.0% or less, more preferably 8.0% or less, and further preferably a deoxidized state. As the deoxidized state, the oxygen concentration may be 1.0% or less, and more preferably 0.1% or less. From the viewpoint of easily maintaining the oxygen concentration in the internal space of the packaging material low, the air conditioning unit is preferably stored in a state in which a deoxidizer is disposed in the internal space of the packaging material. As such a deoxidizer, a self-reaction type deoxidizer that already has moisture necessary for reaction and starts absorption of oxygen from the moment of contact with air is preferable. For example, iron powder, zeolite, sodium chloride, activated carbon, and a mixture thereof can be preferably used. The amount of the deoxidizer to be used is preferably, for example, an amount that attains an absorption amount equal to or more than a value obtained by multiplying the internal space of the packaging material (the volume inside the packaging material minus the volume of the air conditioning unit) by the percentage of oxygen in air (21%).

An inert gas is preferably enclosed in the internal space of the packaging material. The inert gas may be any one of helium, neon, argon, krypton, xenon, radon, nitrogen, carbon dioxide, fluorocarbon (excluding a refrigerant having flammability), and a mixed gas thereof. The inert gas may be a flue gas having a low oxygen concentration, such as an exhaust gas generated by combustion of fuel. In addition, when the inert gas is enclosed in the internal space of the packaging material, the deoxidizer may be further used.

### (3) Example of Case Where Air Conditioning Unit is Outdoor Unit

Hereinafter, an air conditioning apparatus 1 in which an outdoor unit as an air conditioning unit is used will be described as an example.

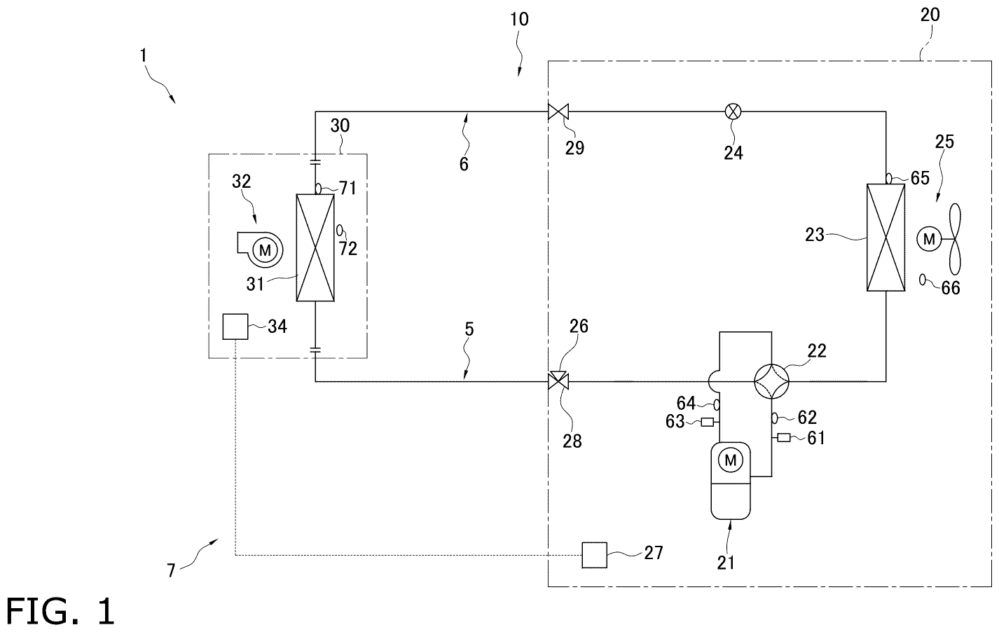

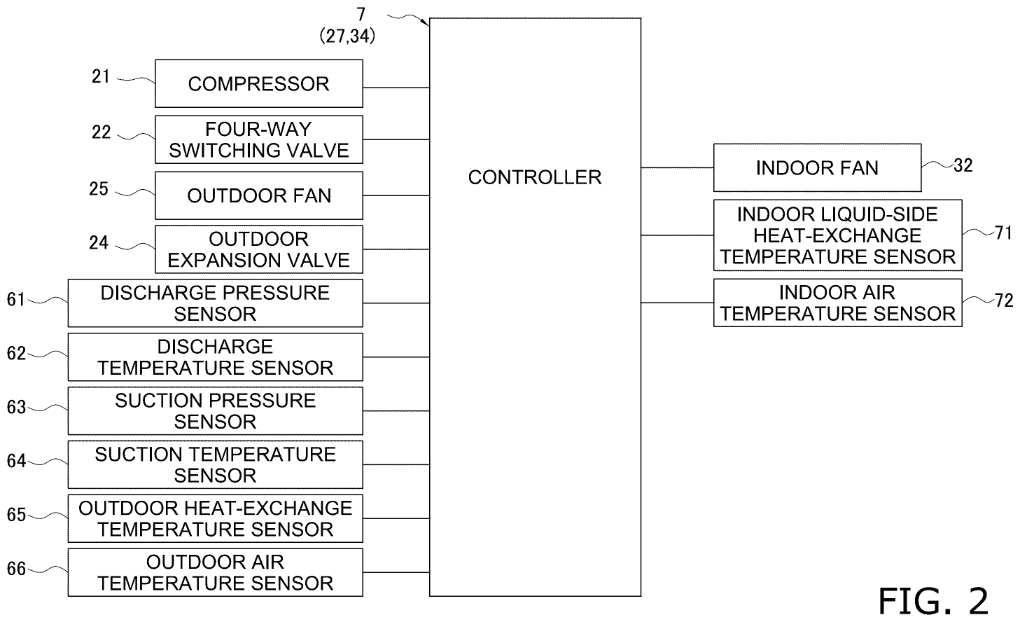

FIG. 1 is a general configuration diagram of the air conditioning apparatus 1. FIG. 2 is a general control block configuration diagram of the air conditioning apparatus 1.

The air conditioning apparatus 1 is an apparatus that controls the condition of air in a subject space by performing a vapor compression refrigeration cycle.

The air conditioning apparatus 1 mainly includes an outdoor unit 20, an indoor unit 30, a liquid-side connection pipe 6 and a gas-side connection pipe 5 that connect the outdoor unit 20 and the indoor unit 30 to each other, a remote controller (not illustrated) serving as an input device and an output device, and a controller 7 that controls operations of the air conditioning apparatus 1.

The air conditioning apparatus 1 performs a refrigeration cycle in which a refrigerant enclosed in a refrigerant circuit 10 is compressed, cooled or condensed, decompressed, heated or evaporated, and then compressed again. In the present embodiment, the refrigerant circuit 10 is filled with a refrigerant for performing a vapor compression refrigeration cycle. The refrigerant is a refrigerant having flammability. In addition, the refrigerant circuit 10 is filled with a refrigeration oil together with the refrigerant having flammability.

### (3-1) Outdoor Unit 20

The outdoor unit 20 is connected to the indoor unit 30 via the liquid-side connection pipe 6 and the gas-side connection pipe 5, and constitutes a part of the refrigerant circuit 10. The outdoor unit 20 mainly includes a compressor 21, a four-way switching valve 22, an outdoor heat exchanger 23, an outdoor expansion valve 24, an outdoor fan 25, a liquid-side shutoff valve 29, a gas-side shutoff valve 28, and a service port 26.

The compressor 21 is a device that compresses the refrigerant with a low pressure in the refrigeration cycle until the refrigerant becomes a high-pressure refrigerant. In this case, a compressor having a hermetically sealed structure in which a compression element (not illustrated) of positive-displacement type, such as rotary type or scroll type, is rotationally driven by a compressor motor is used as the compressor 21. The compressor motor is for changing the capacity, and has an operational frequency that can be controlled by an inverter.

The four-way switching valve 22, by switching the connection state, can switch the state between a cooling operation connection state in which the discharge side of the compressor 21 is connected to the outdoor heat exchanger 23 and the suction side of the compressor 21 is connected to the gas-side shutoff valve 28, and a heating operation connection state in which the discharge side of the compressor 21 is connected to the gas-side shutoff valve 28 and the suction side of the compressor 21 is connected to the outdoor heat exchanger 23.

The outdoor heat exchanger 23 is a heat exchanger that functions as a condenser for the high-pressure refrigerant in the refrigeration cycle during cooling operation and that functions as an evaporator for the low-pressure refrigerant in the refrigeration cycle during heating operation.

The outdoor fan 25 sucks outdoor air into the outdoor unit 20, causes the outdoor air to exchange heat with the refrigerant in the outdoor heat exchanger 23, and then generates an air flow to be discharged to the outside. The outdoor fan 25 is rotationally driven by an outdoor fan motor.

The outdoor expansion valve 24 is provided between a liquid-side end portion of the outdoor heat exchanger 23 and the liquid-side shutoff valve 29. The outdoor expansion valve 24 may be a mechanical expansion valve used together with a capillary tube or a temperature sensitive tube, but is preferably an electric expansion valve that can adjust a valve opening degree by control.

The liquid-side shutoff valve 29 is a manual valve disposed in a connection portion of the outdoor unit 20 with respect to the liquid-side connection pipe 6.

The gas-side shutoff valve 28 is a manual valve disposed in a connection portion of the outdoor unit 20 with respect to the gas-side connection pipe 5.

The service port 26 is provided adjacent to the gas-side shutoff valve 28, and is a manual valve disposed in the connection portion of the outdoor unit 20 with respect to the gas-side connection pipe 5.

The outdoor unit 20 includes an outdoor-unit control unit 27 that controls operations of respective sections constituting the outdoor unit 20. The outdoor-unit control unit 27 includes a microcomputer including a CPU, a memory, and so forth. The outdoor-unit control unit 27 is connected to an indoor-unit control unit 34 of each indoor unit 30 via a communication line, and transmits and receives a control signal and so forth.

The outdoor unit 20 includes, for example, a discharge pressure sensor 61, a discharge temperature sensor 62, a suction pressure sensor 63, a suction temperature sensor 64, an outdoor heat-exchange temperature sensor 65, and an outdoor air temperature sensor 66. Each of the sensors is electrically connected to the outdoor-unit control unit 27, and transmits a detection signal to the outdoor-unit control unit 27. The discharge pressure sensor 61 detects the pressure of the refrigerant flowing through a discharge pipe that connects the discharge side of the compressor 21 to one of connecting ports of the four-way switching valve 22. The discharge temperature sensor 62 detects the temperature of the refrigerant flowing through the discharge pipe. The suction pressure sensor 63 detects the pressure of the refrigerant flowing through a suction pipe that connects the suction side of the compressor 21 to one of the connecting ports of the four-way switching valve 22. The suction temperature sensor 64 detects the temperature of the refrigerant flowing through the suction pipe. The outdoor heat-exchange temperature sensor 65 detects the temperature of the refrigerant flowing through the outlet on the liquid side of the outdoor heat exchanger 23 opposite to the side connected to the four-way switching valve 22. The outdoor air temperature sensor 66 detects the outdoor air temperature before the air passes through the outdoor heat exchanger 23.

### (3-2) Indoor Unit 30

The indoor unit 30 is installed on a wall surface or a ceiling in a room that is a subject space. The indoor unit 30 is connected to the outdoor unit 20 via the liquid-side connection pipe 6 and the gas-side connection pipe 5, and constitutes a part of the refrigerant circuit 10. In the present embodiment, a case in which one indoor unit 30 is connected to one outdoor unit 20 is described as an example, but a plurality of indoor units may be connected in parallel to one outdoor unit 20.

The indoor unit 30 includes an indoor heat exchanger 31 and an indoor fan 32.

The liquid side of the indoor heat exchanger 31 is connected to the liquid-side connection pipe 6, and the gas-side end thereof is connected to the gas-side connection pipe 5. The indoor heat exchanger 31 is a heat exchanger that functions as an evaporator for the low-pressure refrigerant in the refrigeration cycle during cooling operation and that functions as a condenser for the high-pressure refrigerant in the refrigeration cycle during heating operation.

The indoor fan 32 sucks indoor air into the indoor unit 30, causes the indoor air to exchange heat with the refrigerant in the indoor heat exchanger 31, and then generates an air flow to be discharged to the outside. The indoor fan 32 is rotationally driven by an indoor fan motor.

In addition, the indoor unit 30 includes an indoor-unit control unit 34 that controls operations of respective sections constituting the indoor unit 30. The indoor-unit control unit 34 includes a microcomputer including a CPU, a memory, and so forth. The indoor-unit control unit 34 is connected to the outdoor-unit control unit 27 via a communication line, and transmits and receives a control signal and so forth.

The indoor unit 30 includes, for example, an indoor liquid-side heat-exchange temperature sensor 71 and an indoor air temperature sensor 72. Each of the sensors is electrically connected to the indoor-unit control unit 34, and transmits a detection signal to the indoor-unit control unit 34. The indoor liquid-side heat-exchange temperature sensor 71 detects the temperature of the refrigerant flowing through the outlet on the liquid side of the indoor heat exchanger 31 opposite to the side connected to the four-way switching valve 22. The indoor air temperature sensor 72 detects the indoor air temperature before the air passes through the indoor heat exchanger 31.

### (3-3) Details of Controller 7

In the air conditioning apparatus 1, the outdoor-unit control unit 27 is connected to the indoor-unit control unit 34 via the communication line, thereby constituting the controller 7 that controls operations of the air conditioning apparatus 1.

The controller 7 mainly includes a processor such as a central processing unit (CPU) and memories such as a ROM and a RAM. Various processing and control by the controller 7 are provided when respective sections included in the outdoor-unit control unit 27 and/or the indoor-unit control unit 34 function together.

### (3-4) Operating Mode

Operating modes are described below.

The operating modes include a cooling operating mode and a heating operating mode.

The controller 7 determines whether the operating mode is the cooling operating mode or the heating operating mode and executes the determined mode based on an instruction received from the remote controller or the like.

### (3-4-1) Cooling Operating Mode

In the air conditioning apparatus 1, in the cooling operating mode, the connection state of the four-way switching valve 22 is in the cooling operation connection state in which the discharge side of the compressor 21 is connected to the outdoor heat exchanger 23 and the suction side of the compressor 21 is connected to the gas-side shutoff valve 28, and the refrigerant filled in the refrigerant circuit 10 is circulated mainly sequentially in the compressor 21, the outdoor heat exchanger 23, the outdoor expansion valve 24, and the indoor heat exchanger 31.

More specifically, in the refrigerant circuit 10, when the cooling operating mode is started, the refrigerant is sucked into the compressor 21, compressed, and then discharged.

The compressor 21 performs capacity control in accordance with a cooling load required for the indoor unit 30. The gas refrigerant discharged from the compressor 21 passes through the four-way switching valve 22 and flows into the gas-side end of the outdoor heat exchanger 23.

The gas refrigerant which has flowed into the gas-side end of the outdoor heat exchanger 23 exchanges heat with outdoor-side air supplied by the outdoor fan 25, hence is condensed and turns into a liquid refrigerant in the outdoor heat exchanger 23, and flows out from the liquid-side end of the outdoor heat exchanger 23.

The refrigerant which has flowed out from the liquid-side end of the outdoor heat exchanger 23 is decompressed when passing through the outdoor expansion valve 24. The refrigerant decompressed at the outdoor expansion valve 24 passes through the liquid-side shutoff valve 29 and the liquid-side connection pipe 6, and flows into the indoor unit 30.

The refrigerant which has flowed into the indoor unit 30 flows into the indoor heat exchanger 31; exchanges heat with the indoor air supplied by the indoor fan 32, hence is evaporated, and turns into a gas refrigerant in the indoor heat exchanger 31; and flows out from the gas-side end of the indoor heat exchanger 31. The gas refrigerant which has flowed out from the gas-side end of the indoor heat exchanger 31 flows to the gas-side connection pipe 5.

The refrigerant which has flowed through the gas-side connection pipe 5 passes through the gas-side shutoff valve 28 and the four-way switching valve 22, and is sucked into the compressor 21 again.

### (3-4-2) Heating Operating Mode

In the air conditioning apparatus 1, in the heating operating mode, the connection state of the four-way switching valve 22 is in the heating operation connection state in which the discharge side of the compressor 21 is connected to the gas-side shutoff valve 28 and the suction side of the compressor 21 is connected to the outdoor heat exchanger 23, and the refrigerant filled in the refrigerant circuit 10 is circulated mainly sequentially in the compressor 21, the indoor heat exchanger 31, the outdoor expansion valve 24, and the outdoor heat exchanger 23.

More specifically, in the refrigerant circuit 10, when the heating operating mode is started, the refrigerant is sucked into the compressor 21, compressed, and then discharged. The gas refrigerant discharged from the compressor 21 flows through the four-way switching valve 22 and the gas-side connection pipe 5, and then flows into the indoor unit 30.

The refrigerant which has flowed into the indoor unit 30 flows into the gas-side end of the indoor heat exchanger 31; exchanges heat with the indoor air supplied by the indoor fan 32, hence is condensed, and turns into a refrigerant in a gas-liquid two-phase state or a liquid refrigerant in the indoor heat exchanger 31; and flows out from the liquid-side end of the indoor heat exchanger 31. The refrigerant which has flowed out from the liquid-side end of the indoor heat exchanger 31 flows to the liquid-side connection pipe 6.

The refrigerant which has flowed through the liquid-side connection pipe 6 flows into the outdoor unit 20, passes through the liquid-side shutoff valve 29, and is decompressed to a low pressure in the refrigeration cycle at the outdoor expansion valve 24. The refrigerant decompressed at the outdoor expansion valve 24 flows into the liquid-side end of the outdoor heat exchanger 23.

The refrigerant which has flowed in from the liquid-side end of the outdoor heat exchanger 23 exchanges heat with the outdoor air supplied by the outdoor fan 25, hence is evaporated and turns into a gas refrigerant in the outdoor heat exchanger 23, and flows out from the gas-side end of the outdoor heat exchanger 23.

The refrigerant which has flowed out from the gas-side end of the outdoor heat exchanger 23 passes through the four-way switching valve 22 and is sucked into the compressor 21 again.

### (4) Installation of Air Conditioning Apparatus 1

The air conditioning apparatus 1 is installed such that the outdoor unit 20 filled with a predetermined amount of the refrigerant and the indoor unit 30 not filled with the refrigerant are carried into an installation site in a state of being separated from each other, and are connected to each other by the gas-side connection pipe 5 and the liquid-side connection pipe 6.

The lengths of the gas-side connection pipe 5 and the liquid-side connection pipe 6 that connect the outdoor unit 20 and the indoor unit 30 to each other differ according to the conditions of the installation site. Thus, an amount of the refrigerant smaller than an amount of refrigerant required to appropriately perform a refrigeration cycle in the refrigerant circuit 10 is enclosed in advance in the outdoor unit 20. Then, after the refrigerant circuit 10 is formed by connecting the outdoor unit 20 and the indoor unit 30 to each other by the gas-side connection pipe 5 and the liquid-side connection pipe 6, the refrigerant, which is insufficient for appropriately performing the refrigeration cycle, is additionally charged from the service port 26. Specifically, a refrigerant cylinder is connected to the service port 26, and the refrigerant is additionally charged into the refrigerant circuit 10. When the refrigerant is additionally charged into the refrigerant circuit 10 via the service port 26, the refrigerant may be charged into the refrigerant circuit 10 while the refrigeration cycle is performed by the compressor 21 being driven. When the additional charging of the predetermined amount of the refrigerant is finished, the service port 26 is closed.

### (5) Storage and Transportation of Outdoor Unit 20

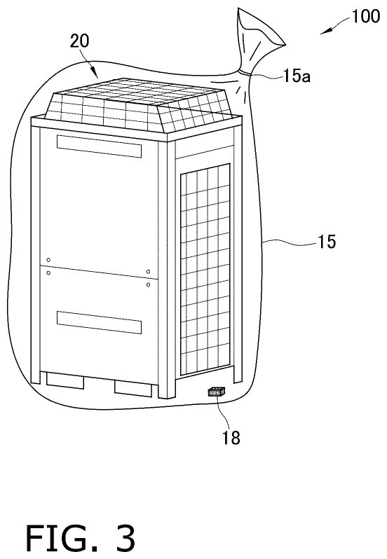

As illustrated in FIG. 3, the outdoor unit 20 is stored and transported in a state of being packaged with a packaging material 15. Specifically, a packaging unit 100 is constituted of the outdoor unit 20 and the packaging material 15.

The service port 26, the liquid-side shutoff valve 29, and the gas-side shutoff valve 28 are each closed in a state in which the refrigerant having flammability is enclosed in the outdoor unit 20 packaged with the packaging material 15 by an amount equal to or more than an amount of the refrigerant that becomes an atmospheric pressure at an ambient temperature of −40° C. and less than an amount of the refrigerant that becomes 0.2 MPa at an ambient temperature of 20° C.

The packaging material 15 packages the entire outdoor unit 20 and isolates the outdoor unit 20 from air outside the packaging material 15. The packaging material 15 is formed in a bag shape made of a material having no air permeability and is sealed at a fastening portion 15a in a state in which the outdoor unit 20 is packaged.

A deoxidizer 18 is disposed on the periphery of the outdoor unit 20 in the internal space of the packaging material 15. By using the deoxidizer 18 in this way, the internal space of the packaging material 15 is maintained in a state in which the oxygen concentration is low. The disposition of the deoxidizer 18 is not limited, but when the outdoor unit 20 is filled with a refrigerant having flammability and having a specific gravity greater than that of the atmosphere, the deoxidizer 18 is preferably disposed at a height position lower than the service port 26, the liquid-side shutoff valve 29, and the gas-side shutoff valve 28. The internal space of the packaging material 15 may be filled with an inert gas.

The outdoor unit 20 is stored in a state of the packaging unit 100, and is transported to an installation site. The packaging unit 100 is preferably stored and transported in an environment at an ambient temperature of −4° C. or higher. The packaging material 15 is removed at the time of installation.

### (Appendix)

While the embodiment of the present disclosure has been described above, it is understood that the embodiment and details can be changed in various ways without departing from the gist and scope of the present disclosure described in the claims.

### REFERENCE SIGNS LIST

1 air conditioning apparatus
7 controller
10 refrigerant circuit
15 packaging material
18 deoxidizer
20 outdoor unit (air conditioning unit, outdoor unit)
21 compressor
23 outdoor heat exchanger
24 outdoor expansion valve
25 outdoor fan
30 indoor unit (indoor unit)
31 indoor heat exchanger
32 indoor fan
100 packaging unit

### CITATION LIST

### Patent Literature

PTL 1: Japanese Unexamined Patent Application Publication No. 2011-094871

1. An air conditioning unit,
wherein a refrigerant having flammability is enclosed, and
wherein an enclosure amount of the refrigerant having the flammability is equal to or more than an amount of the refrigerant that becomes an atmospheric pressure at an ambient temperature of −40° C. and less than an amount of the refrigerant that becomes 0.2 MPa at an ambient temperature of 20° C.

2. The air conditioning unit according to claim 1, wherein the air conditioning unit is an outdoor unit that is connected to an indoor unit.

3. The air conditioning unit according to claim 1, wherein the refrigerant having the flammability contains one type or two or more types selected from the group consisting of R290, R600, and R600a.

4. A packaging unit comprising:
the air conditioning unit according to claim 1; and
a packaging material that packages the air conditioning unit,
wherein the air conditioning unit is isolated from air outside the packaging material.

5. The packaging unit according to claim 4, wherein the packaging material contains one type or two or more types selected from the group consisting of vinyl chloride, polyethylene, and polypropylene.

6. The packaging unit according to claim 4, wherein an internal space of the packaging material is in a low oxygen state.

7. The packaging unit according to claim 4, wherein an inert gas is enclosed in an internal space of the packaging material.

8. The packaging unit according to claim 4, further comprising a deoxidizer disposed in an internal space of the packaging material.

9. The air conditioning unit according to claim 2, wherein the refrigerant having the flammability contains one type or two or more types selected from the group consisting of R290, R600, and R600a.

10. A packaging unit comprising:
the air conditioning unit according to claim 2; and
a packaging material that packages the air conditioning unit,
wherein the air conditioning unit is isolated from air outside the packaging material.

11. A packaging unit comprising:
the air conditioning unit according to claim 3; and
a packaging material that packages the air conditioning unit,
wherein the air conditioning unit is isolated from air outside the packaging material.

12. The packaging unit according to claim 5, wherein an internal space of the packaging material is in a low oxygen state.

13. The packaging unit according to claim 5, wherein an inert gas is enclosed in an internal space of the packaging material.

14. The packaging unit according to claim 6, wherein an inert gas is enclosed in an internal space of the packaging material.

15. The packaging unit according to claim 5, further comprising a deoxidizer disposed in an internal space of the packaging material.

16. The packaging unit according to claim 6, further comprising a deoxidizer disposed in an internal space of the packaging material.

17. The packaging unit according to claim 7, further comprising a deoxidizer disposed in an internal space of the packaging material.
